(19) United States
(12) Patent Application Publication
(10) Pub. No.: US 2004/0083164 A1
(43) Pub. Date: Apr. 29, 2004

(54) System and method for generating residential loan documents from multiple and diverse databases

(76) Inventors: Dennis P. Schwartz, Fairview, TX (US); William B. Mow, Plano, TX (US)

Correspondence Address: Hughes & Luce, LLP, Suite 2800, 1701 Main Street, Dallas, TX, 75201, US

(21) Appl. No.: 10/614,969

(22) Filed: Jul. 8, 2003

Related U.S. Application Data
(60) Provisional application No. 60/394,408, filed on Jul. 8, 2002.

(51) Int. Cl. G06F 17/60

(52) U.S. Cl. 705/38

(57) ABSTRACT

The present invention provides a system for preparing loan documents that uses multiple and diverse databases. The present invention uses a first database to store data and procedures for processing data provided by a mortgage originator. A second database stores data and procedures from an investor for processing the provided data. A comparison engine compares the provided data and identifies discrepancies between the originator and investor data and allows those discrepancies to be viewed and reconciled. A documentation preparation engine receives additional information from the users to prepare loan documents with the reconciled data and any additional information. A compliance engine audits the reconciled data and additional information to ensure consistency with procedures and compliance requirements and allows noncompliant data to be identified and reconciled. Documents from the forms library are then populated with the information and delivered by a documentation delivery engine to the end user.

### RELATED APPLICATIONS

This application claims the benefit of provisional patent application No. 60/394,408 filed Jul. 8, 2002, entitled, “System and Method for Generating Residential Loan Documents from Multiple and Diverse Databases.”

### TECHNICAL FIELD OF THE INVENTION

The present invention relates generally to systems and methods of preparing documentation, and more particularly, an improved system and method for preparing residential loan documents that proactively identifies and eliminates potential errors by reconciling discrepancies and synchronizing data between multiple and diverse databases using business logic from multiple entities.

### BACKGROUND OF THE INVENTION

According to estimates, mortgage bankers spend in excess of $150 million per year fixing errors associated with closing documents for mortgages. These errors are often caused by erroneous or incorrect information mistakenly supplied by mortgage originators to their investors. Costs for these errors arise from the fact that these errors are not identified until after closing. Currently, no systems or methods proactively identify and prevent the errors prior to the closing and funding of the loan. In current systems mortgage originators maintain loan data used to prepare the closing documents. If mortgage originators prepare the loan documentation, the investor has no control over the data flow from the mortgage originator to the closing documents, and the investor cannot prevent these errors from occurring. Furthermore, existing document preparation systems and origination software systems do not allow closing documentation to be customized to an individual investors business needs.

Existing systems were, for the most part, created by software companies, which merely attempted to fit their existing software applications to the residential mortgage industry. These systems are desktop applications residing on the computer systems of each and every user, which translates to non-centralized information that is difficult to maintain and update. These attempts to bring improved document automation to the mortgage industry have many problems. Typically, these solutions are generic and rigid in nature and comprise a set of electronic documents. Their input processes lack the intuitive or logical flow associated with the preparation of residential mortgage documents. They also lack the flexibility required to address unique or complex solutions. The resultant set of documents are “cookie cutter” packages and address only a limited number of loan types such as those provided by FHA, VA, or FNMA/FHLMC Conventional Loans. These software applications require multiple and repetitive manual data entries, which are susceptible to transcription errors. Since the document package is generic in nature, many unnecessary data entries are presented to users for completion. The presentation of unnecessary and misleading data fields not applicable to the current loan complicates matters and confuses the user.

As previously stated, these software solutions rely heavily on the loan originator's data and do not compare information obtained from multiple databases and from different sources. Investors cannot control information that is submitted from the originator. As a result they are unable to ensure their specific business rules or compliance requirements are adhered to. Required data by the investor may or may not be within the information supplied by the originator. Since investor business rules and compliance requirements may not be applied to individual loan packages, packages that would not normally be processed or accepted by investors are submitted and approved without a thorough and qualitative review, causing a substantial loss for the investor.

The errors found in these loans often include but are not limited to: the failure to properly document the proper expiration date for a given interest rate; an improperly listed interest rate; the wrong loan program being cited for an individual loan application; or the failure to include investor fees within the individual loan. If for example, an individual investor's fees are not present in the documentation, the fees are not paid when the mortgage is funded. Other elements of the funding are paid; however, the investor's fees, if omitted are not. The revenue streams from these fees, which vary per loan, are forever lost.

Another typical problem occurs when the loan documentation supports the wrong loan program. This often occurs when generic information is gathered. Since current software applications gather a great deal of generic and often extraneous information, documents can be properly prepared for the wrong loan program. This can result in the funding of loans that do not qualify for specific programs. When this occurs, investors must discount those loans in order to sell them in the secondary market, and in so doing incur a loss.

One example is the 3-1 lock wherein the mortgage is closed as a 5-1 lock. This error may not be identified until 2 to 5 weeks after closing. If the mistake is identified after the lock has expired, the investor must discount that individual loan because of the error. Another common error involves private mortgage insurance (PMI). When a loan has a loan to value ratio greater than 80 percent, PMI is required. If PMI is not properly purchased at closing, investors must purchase, at their own expense, a fully paid PMI policy. Investors pay substantial amounts as one-time buyouts for the failure to properly include PMI at the mortgage's inception.

When interest rates increase, these errors can cause the loan in question to be at a lower rate than the current market, creating difficulty in realizing the value of these loans. To correct these errors, investors must again discount the value to account for the increased interest rates.

A means of proactively detecting and correcting errors before closing would be extremely valuable within the mortgage industry. Centrally maintaining and auditing data in one location could help prevent these errors. Thus, a comparison of the data provided by the originator to what is required by the investor for a specific loan could ensure that the loan fully meets the investor's requirements. Furthermore, it is desirable by most investors to offload the documentation preparation to mortgage originators, while maintaining quality control and ensuring compliance within the various loan programs.

### SUMMARY OF THE INVENTION

The present invention provides a system and method for preparing residential loan documents that substantially eliminates or reduces disadvantages and problems associated with previously developed systems.

More specifically, the present invention provides a purely Web-based solution for preparing residential loan documents that is capable of utilizing multiple and diverse databases from different sources. The present invention is designed to receive data from different database sources (mortgage originator, mortgage banker, title company etc.) as those sources develop the ability to transmit said data. A comparison engine compares the provided data and identifies discrepancies with the incoming data. Next, the discrepancies are viewed and reconciled pursuant to the logic or business rules established by the entities involved. A documentation preparation engine receives any additional information from the user. A compliance engine audits the reconciled data and additional information to ensure consistency with procedures and compliance requirements, and allow noncompliant data to be identified and reconciled. Documents from the forms library are then populated with the information and delivered by a documentation delivery engine to the end user.

By avoiding the labor-intensive practices of prior art solutions; common transcription errors are prevented within the final mortgage documents. Additionally, by comparing data as provided by different users, data entry is standardized throughout the documentation preparation process.

Another advantage provided by the present invention is the ability for investors to delegate the preparation of closing documents to originators while maintaining a level of quality control. Thus, the opportunity for originators to create errors within the residential loan documents is minimized. This is achieved by providing the investor with the ability to control or limit the originator's action. Investors can force mortgage originators to observe the investor's business rules as well as any other compliance requirements. The investors can limit what information the originator can enter, and what documents are available. Once a loan program or type is selected only consistent information with that program, the investor's business rules, or other compliance requirements, will be accepted by the system and method of the present invention.

An example of an individual business rule is the investor restricting the number of days an originator can “short pay.” A “Short Pay” allows a buyer to make a nonstandard loan payment at the beginning of the first month immediately following closing. An overwhelming majority of mortgage notes closed that are sold to Fannie Mae, Freddie Mac, FHA, or VA require their payments be due on the first of the month. This requirement stems from the securities created by pooling these loans. Currently, when an individual closes on the 20^{th} day of the month, the first payment is not due ten days from closing but rather the first of the first full month following closing. At closing, buyers typically pay the ten days of interest for that month. The same situation arises when one closes at the beginning of the month. For example, if closing occurs on May 2^{nd} the parties may not want to wait until July 1^{st} for the first mortgage payment. It would be more reasonable to receive the first mortgage payment on June 1^{st}. To make this nonstandard payment, a “Short Pay” is utilized. In contrast to the standard rule of receiving the first mortgage payment after the end of the first full month following closing, individual investors may specify rules how far into the month the individual investors are willing to accept a “short pay”. Rules that govern “short pays” are based on the investor's own internal processes. Notes must be entered into the investor's accounting systems prior to acceptance of the first payment. Many notes require more than 10 or 15 days to be entered into the investor's system, thus investors are often unwilling to accept a short pay after the 5^{th} or 8^{th} of the month. The present invention allows this and other business and compliance rules to be entered in order to avoid such problems and address a variety of situations.

The present invention also creates a new market for investors by placing the investors in the business of preparing residential loan documents. By using the system and method of the present invention, the originator actually initiates the residential loan documents, under limitations and controls imposed by the investor. The investor is able to utilize the present invention to provide a service presently provided by third party vendors. The present invention also provides a new revenue stream as it simultaneously reduces errors for all participants.

The present invention not only can utilize data from multiple databases in the preparation of mortgage loan documentation but also has the ability to push back information not held within one of the databases utilizing the system. An example of such usage would be the ability to obtain information from an originators database regarding fees to be collected for the loan transaction. When all the fees are presented to the Application, the regulatory requirements are present to properly prepare a Truth-in-Lending disclosure along with the calculation of the required “adjustment adjustment” needed for proper preparation of the settlement statement. The figures calculated by the system can then be pushed back to the investor database in an automated process instead of manually entered at a later date.

As the mortgage industry continues to automate, numerous databases are being created to prevent fraud seen throughout the industry. The present invention has the ability to draw on these additional databases to provide quality control measures that are increasingly relied upon by the industry to reduce losses caused by fraudulent transactions. Not only can the present invention tap into those databases, but also just prior to the delivery of the documents for execution by the borrowers, any information previously provided can be reverified. Reverification assures that updated information has not been overlooked in making a loan to the prospective borrower. This automated process can save lenders and legitimate borrowers millions of dollars on an annualized basis.

Furthermore, investors can safely offload documentation preparation to orignators with specific limits as to what actions originators may perform dependenton investors business rules and other compliance regulations. This may result in a reduction in the demand that these errors place on an investor's statf.

The present invention provides a significant improvement over existing systems in that the present invention allows the originator or the investor to generate high quality customized documents for a nearly unlimited number of loan types while minimizing errors associated with data entry in the residential loan documentation preparation process.

Investors maintain control of residential loan documentation preparation and ensure that various compliance requirements are met prior to closing. This reduces costs associated with individual loans. Another advantage lies in the fact that the present invention allows for interfaces that tailor themselves to a wide variety of residential loan programs per the requirements of each investor.

The present invention provides a great number of advantages over existing loan documentation preparation systems. Primarily, the present invention prevents many costly errors, thus reducing post-closing costs associated with residential loans. These errors often cost tens of thousands of dollars, dependent on the discounts necessary to correct these errors. By providing a system and method wherein information or valuations, which have not traditionally been properly audited prior to closing, are proactively examined, these errors are prevented. Furthermore, the present invention allows investors to safely offload documentation preparation to originators with specific limits as to what actions originators may perform dependent on investors' business rules and other compliance regulations. This may result in a reduction in the demand that these errors place on an investor's staff.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts an embodiment of the present invention;

FIG. 2 provides a screenshot of a “Discrepancy Report” generated by the present invention;

FIG. 3 presents screenshots to be viewed by a user;

FIGS. 4A and 4B present screenshots of the interface provided by the present invention;

FIG. 5 provides a general flowchart depicting the stages of loan document preparation addressed by the present invention;

FIG. 6 depicts a situation wherein property located near the border of two counties can lead to mortgage insurability issues;

FIG. 7 provides screenshot of a “Document Set” page depicting various delivery options for document packages as provided by the present invention;

FIG. 8 provides a flowchart illustrating the flow of information within the present invention;

FIG. 9 illustrates a simplified version of the present invention;

FIG. 10 illustrates an intermediate version of the present invention;

FIGS. 11A and 11B illustrates a variety of business rules;

FIGS. 12A and 12B illustrate various investor defaults;

FIG. 13 illustrates various business rules that may be associated with specific originators.

FIG. 14 depicts default forms to be associated with an individual investor; and

FIG. 15 depicts an audit setup.

### DETAILED DESCRIPTION OF THE INVENTION

Preferred embodiments of the present invention are illustrated in FIGUREs, like numerals being used to refer like and corresponding parts of the various drawings.

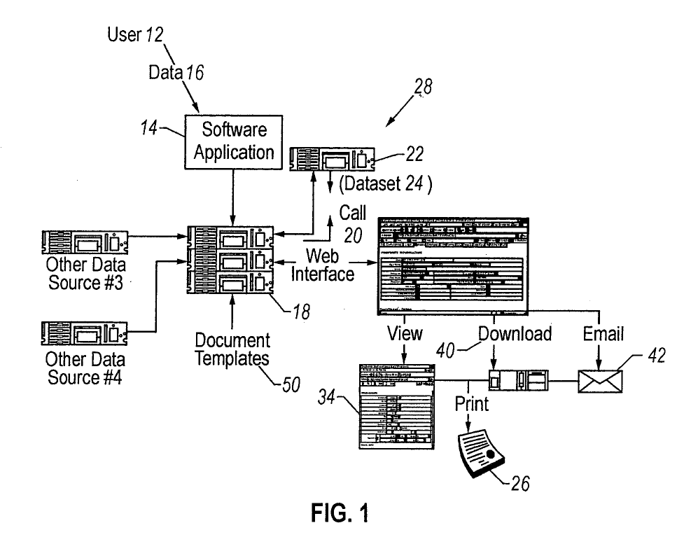

One embodiment of the present invention is illustrated in FIG. 1. Here originator 12 uses software application 14, such as a Loan Origination Software (LOS) package, like the commercially available package POINT® or other such software packages as is known to those skilled in the art, to enter data about a residential loan. Data 16 is collected and entered by originator 12 via software package 14 to network server 18. Network server 18 may be connected to software package 14 by any network or Internet type connection. Network server 18 assigns mortgage data 16 a unique identifier, such as an import number. Network server 18 issues a call or request 20 to investor's database 22. Database 22 may utilize a unique identifier such as a loan number or Social Security Number (SSN) to gather investor mortgage data set 24 that is related to that mortgage application. Investor's database 22 then delivers data set 24 to network server 18.

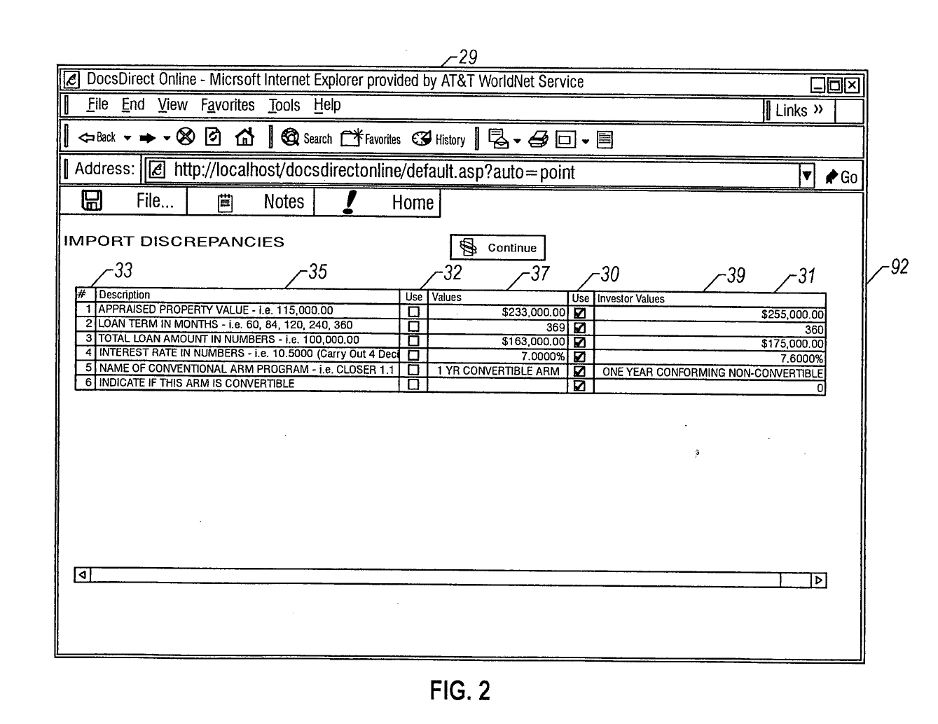

Investor's data set 24 is compared to the originators' mortgage data 16. FIG. 2 illustrates the results of this comparison in the “Discrepancies Report” screenshot shown as being viewed by browser 29. Discrepancies between data sets 16 and 24 are clearly identified in import discrepancies table 31. This table lists the discrepant items. Column 33 enumerates the items described in column 35. “Use” columns 30 and 32 inform the viewer which values from columns 37 and 39 may be used to resolve the discrepancy. In this specific case, originator 12 of FIG. 1 had an appraised value of $233,000.00, while investor 28 had an appraised value of $255,000.00. Similarly, originator 12 supplied a term of 369 months, while investor 28 had a set term of 360 months. The loan amount was yet another discrepancy. Perhaps even more significant, originator 12 entered one-year convertible adjustable rate mortgage (ARM) 7% differed from investor's 7.5% one-year conforming non-convertible mortgage. “Use” column 32 indicates which discrepant values investor 28 will permit to be completed with data from originator 12. As indicated by the checkmarks in “Use” column 30, the investor's values are set as the only values, which can be used to resolve these discrepancies. In other instances investor 28 may allow originator 12 to change these values. Thus, by this mechanism, investor 28 can determine what fields individual originator 12 can manipulate. Investor 28 is much less likely to allow originator 12 to directly manipulate interest rates or the type of mortgage to be funded. Thus, investor 28 controls what data originator 12 must provide in order to receive a set of residential loan documents 26. In the embodiment shown in FIG. 2, all of the investor date is to be used going forward.

However, if originator 12 had locked the 7% rate as shown in FIG. 2, investor 28 must change the value from 7.5 to 7 if the 7% rate is to be used for the documents of this particular loan. FIG. 2 demonstrates how costly errors typically found in residential loan documents are proactively identified and corrected. The discrepant items may comprise the previously identified items or any other item supplied by the investor or originator. The present invention allows originators and investors to quickly identify and eliminate these discrepancies prior to the final preparation and execution of the mortgage documents 26. Eliminating these errors prior to execution and funding avoid unnecessary charges incurred by the investors.

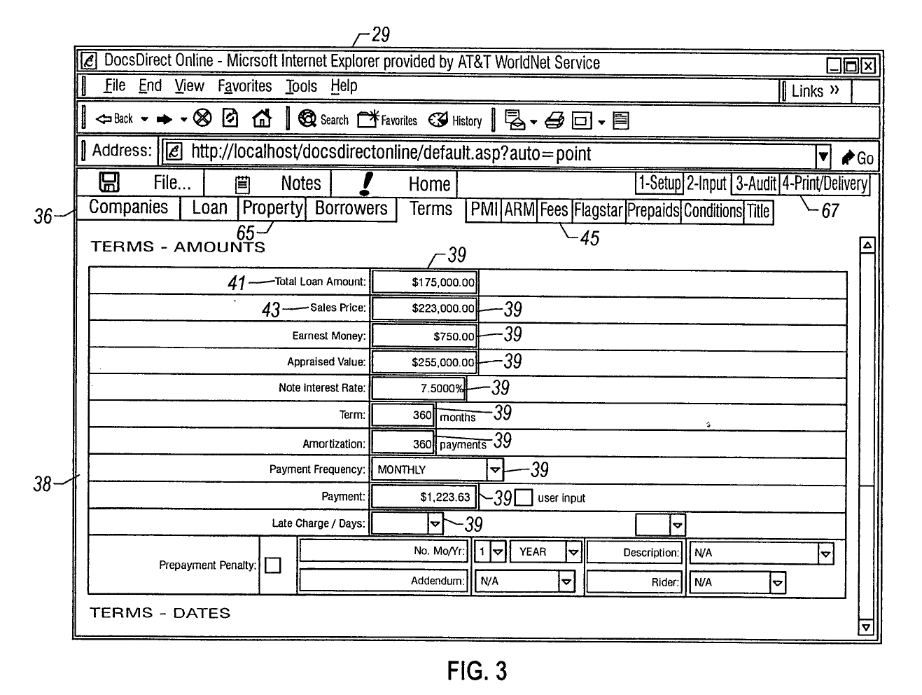

After the discrepancies have been identified, the originator enters the application data set into the system using a set of intelligent web based forms. FIG. 3 shows how data may be presented to the originator via browser 29. Here loan terms are displayed by selecting the “Terms” tab from tabs 36. Data fields 39 may be color coded or formatted such that the viewer clearly understands the source and status of the data by the format of the displayed field. In the example shown, “Total Loan Amount” field 41 may have a blue or shaded background. This color is not depicted in the FIGURES. This blue or shaded background informs the viewer that the field contains investor data. “Sales Price” field 43 may have a different background or color to identify the originator as the source of the displayed data. Protected data fields are identified by yet another format, such as a gray background. Yet another format or background identifies protected data, supplied by the investor, which the originator typically cannot manipulate. Still yet another format may identify investor defaults. Such defaults include standard investor data used on all loans. These defaults might include late charges and other loan terms. In one embodiment, turquoise or another identifying color or format may be used to identify standard inventor data.

Web forms or pages 38 are automatically and consistently populated with reconciled data from originator's database 16 and investor data set 24. This expedites the residential loan process while eliminating many clerical errors. Furthermore, as discussed in the description of FIG. 3, data field 39 may be coded by format, color, shade or texture to readily identify the source and access associated with individual fields. For the example shown in FIG. 3, the originator may change the appraised value but cannot change either the interest rate or loan amount. Various loan default values also populate the documents.

These investor loan defaults may be based on business rules supplied by the investor. The defaults, as supplied by the investor, may or may not be manipulated by the originator. This access depends on the type and level of access granted by the investor to the originator.

To complete the data entry process the originator or other user navigates the various web pages 38 and associated interfaces, which are presented in a logical flow consistent with that specific loan. These screens are accessible from tabs 36. They include pages for the originator and investor, loan, property, terms, PMI, ARM, fees, prepaids, conditions, title or other pages for required entries associated with this particular mortgage as is known to those skilled in the art.

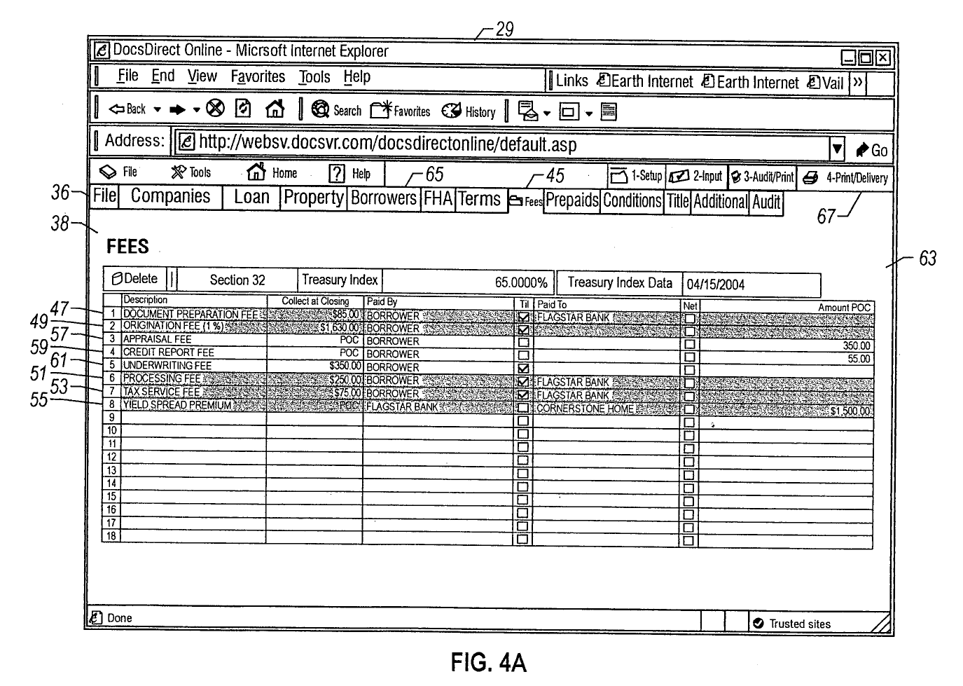

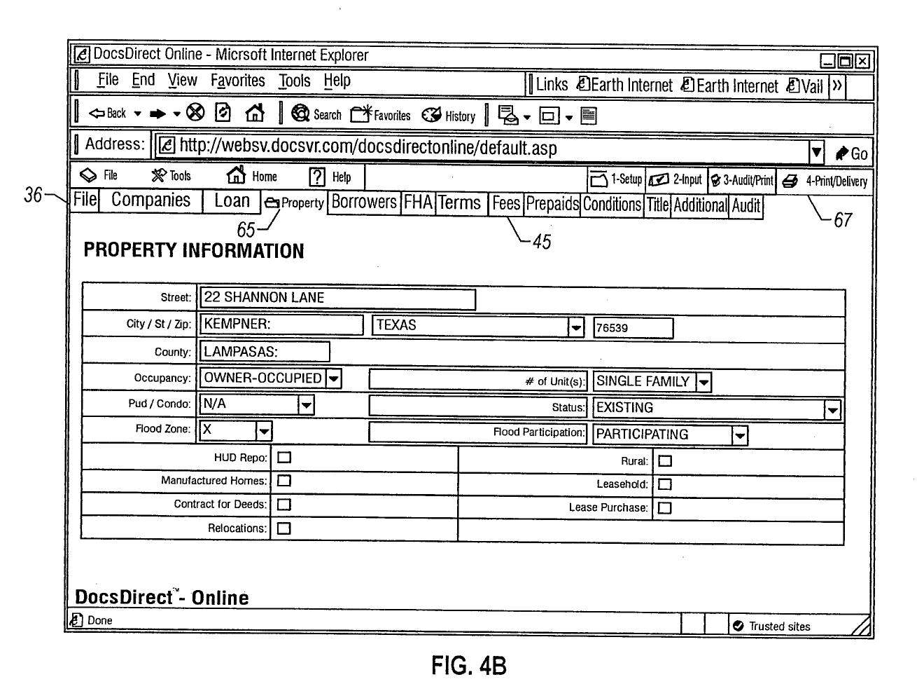

In the screen shot of browser 29 shown in FIG. 4A fee tab 45 is selected. Here, business rules specify the inability for the originator to delete the investor's fees (indicated with the dark highlight). These fees include document preparation fee 47, origination fee 49, processing fee 51, tax service fee 53, and yield spread premium 55. The appraisal fee 57, credit report fee 59, and underwriting fee 61 are not highlighted and may be excluded by the originator. Thus, the originator at closing cannot exclude the investor's fees. This level of investor control prevents loss of revenue to the investor. Therefore, investors are able to guarantee that their fees and other specified requirements are fulfilled; otherwise the loan will not be successfully processed and funded.

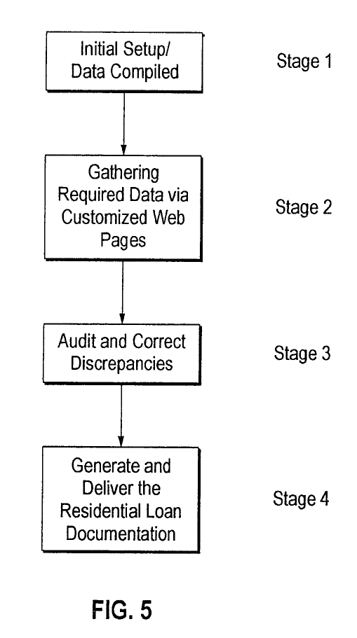

The overall process is divided into four separate stages as illustrated in the flow chart provided by FIG. 5. In STAGE 1, the initial setup information is gathered and provided to the network server at which point the server compiles the data and customizes the user input process for STAGE 2. In this stage, required data is gathered to complete the documents. The data collection process is facilitated by the links from tabs 36 provided in various screenshots of FIGS. 3, 4A, and 4B. Tabs 36 are linked to intelligent data collection forms. FIG. 4B provides a screenshot of browser 29 wherein property tab 65 has been selected. Here the originator inputs and reviews information describing the property related to this residential loan. The current stage of the process is depicted by toolbar 67 located immediately above and to the right of tabs 36. Once a residential loan program has been selected, the web based intelligent data collection forms 63 are automatically configured to be consistent with that selection. This eliminates the collection of extra and often inconsistent information, which previously resulted in conflicting documents at closing.

Investor rules and/or business logic are applied between each stage and may comprise an extremely sophisticated set of rules. For example, a description of whether or not a “short pay” will be accepted following closing and what the terms for that “short pay” are is one example. Other examples of investor business rules include, but are not limited to, which payment addresses an investor chooses to receive their payments. Investors may choose to associate one payment address with first mortgages and associate a different payment address with additional liens. Therefore, when the residential loan documents are prepared for closing, the proper payment addresses are listed based on the conditions of the mortgage.

Another example describes the required resources to be maintained within an escrow account. In a state such as Texas, there may be no required reserves associated with the escrow account. In another state, such as North Carolina, the required reserves may be equal to one month's worth of taxes and insurance while in the vast majority of states the requirement is two months. This escrow requirement is based on state laws and maintained by investors.

The loan originator supplies required data to the various web-based data collection forms 63 within the input stage. During STAGE 2, the originator can review all data and manipulate any data the originator has access to. Certain data manipulations require approval and execution by the investor. Investor business rules allow direct manipulations to be made on data entered within the various data collection forms dependent on the access level granted to the originator.

After the necessary data has been gathered, the data is audited and discrepancies are corrected in STAGE 3, prior to generating and delivering the residential loan documentation in STAGE 4. This audit is based on investor's business rules or other compliance requirements. These discrepancies may or may not be critical depending on the specific data field identified and loan type.

For example, on a conventional loan to be sold to Fannie Mae an 80 percent loan to value is required. If this is not achieved, mortgage insurance is required. One business rule might require that a private mortgage insurance (PMI) policy be ordered for any loan where the loan to value exceeds 80 percent. This prevents the loan from closing or the preparation of loan documentation unless PMI is included as part of that package. There are some exceptions to this rule such as VA mortgages, which do not require a minimum 80 percent loan to value or PMI. Similarly, for a VA loan or a FHA loan, the proper funding fees must accompany the loan and be made part of the closing package; otherwise, the loan might not be closed and funded improperly.

For loans originated through Fannie Mae or Freddie Mac, Fannie Mae or Freddie Mac will purchase the mortgage up to a specified amount no matter where in the country the property is located. This differs from FHA, wherein FHA has a unique formula for determining the maximum loan value that FHA will purchase based on the median price within a given county. This means that the amount at which FHA will purchase a mortgage loan varies throughout the United States. Potentially every county in the United States may have different maximum loan values from FHA. It is further conceivable that zip codes of even more localized geographic areas may further break down this type of limit.

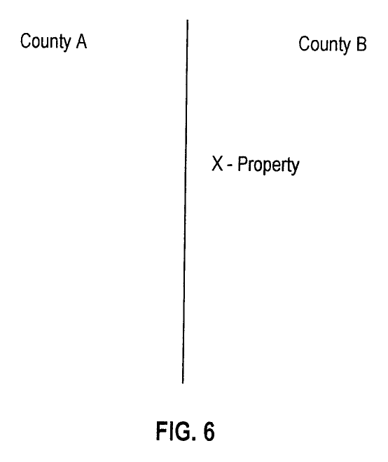

A frequent problem occurs where an individual originator in a FHA county orders a loan for a given amount not realizing that the property is actually located in a different county having a different maximum loan value. For the property illustrated in FIG. 6, County A has a maximum loan value of $170,000.00; County B has a maximum loan value of $130,000.00. The property in question is located close to the border of County A but within County B. If the originator and investor do not realize that the property is located in County B and fund a $170,000.00 loan, then FHA will not purchase this mortgage. The maximum loan the FHA will purchase for this specific property is limited to $130,000.00. Thus, this residential loan is uninsurable according to FHA compliance requirements. In order to insure this individual loan, the investor must discount the value of that mortgage by the difference between what FHA will insure and the loan value. In this example this is a large cost for the investor to incur.

Another common error occurs when discrepancies exist between the closing date and interest rate expiration date. If the closing date is set for August 22, while the loan expiration guaranty expires on August 12, there will be difficulty in funding this loan if rates increase. The audit process will identify this error as well as the other errors mentioned above, but is not limited to these simple errors. Furthermore, the audits are not limited to the investor's business rules, but all compliance rules that have been supplied by and relate to federal, state, and local compliance programs, along with specific agencies or insurance programs associated with individual loan types. Other such compliance rules may be incorporated as business rules into the present invention as known to those skilled in the art.

After the audit process is complete and the discrepancies corrected, the reconciled data is re-audited to determine if changes made in the data have created additional conflicts. Once this re-audit is complete and errors have been reconciled the user proceeds to the Print/Delivery phase or STAGE 4 of FIG. 5. The present invention delivers the documents in a variety of ways. In FIG. 1, Documents 26 may be viewed through user interface 34, download 40 or e-mail 42, printed, or delivered in any other format as is known to those skilled in the art.

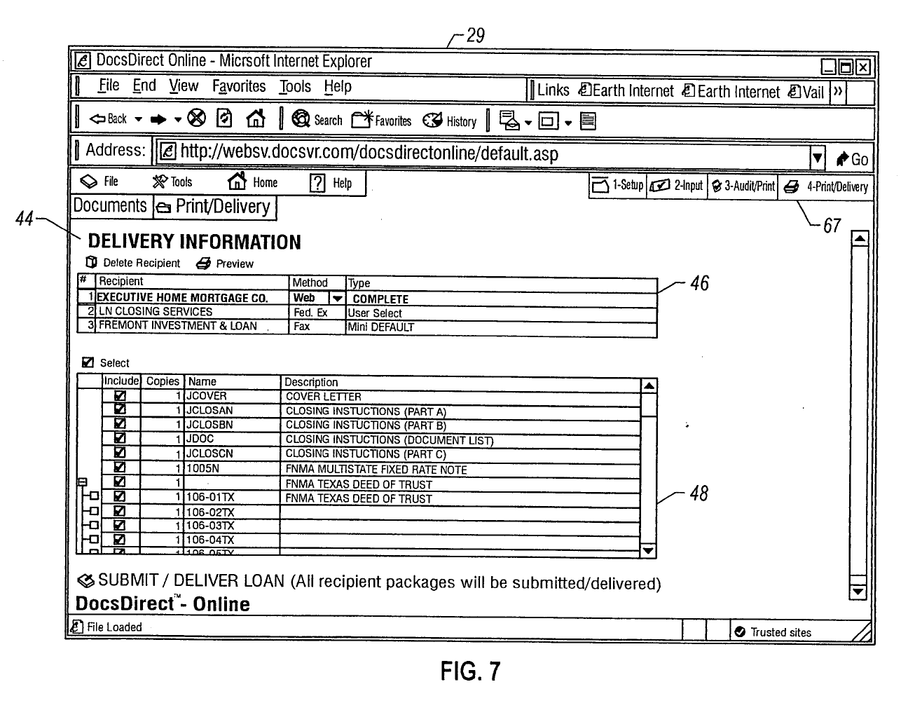

FIG. 7 depicts a “Delivery Information” page 44 within browser 29. This screen shot lists all the documents to be enclosed within a given closing package. Recipient Table 46 describes 3 document sets to be delivered to Executive Home Mortgage, LN Closing Services, and Fremont Investment & Loan. These document sets are to be a “complete”, “user-select” and “mini” default, respectively. Scroll down menu 48 lists the specific documents, quantities and descriptions of the “complete” package selected in Table 46. Further, this package will be delivered via the web.

A set of rules is associated with the document packages for each individual closing. Rules encompass what documents individual loan programs and investors require. All the same criteria, business and compliance rules, may be applied to document delivery. Not all the documents that are available from the forms library are included in a complete package. Rather, the complete package comprises all the documents that are required for that specific loan package.

The present invention allows form level data to be manipulated. Once the setup, input, and audit phases are complete, the originator, depending on rights granted to the originator by the investor, may edit individual data fields within individual documents. This ability is based on user rights supplied by the investor. Although rights may be originator specific, investors may not give the privilege to manipulate individual fields within online documents to all originators. Rather, some trusted originators might have greater abilities to manipulate various fields than other originators, which may not have the ability to manipulate any fields. This prevents the originator from being able to defeat the checks and balances imposed by the investor on the document preparation process through this application of business rules and compliance requirements. For example, Investor A may specify that of the 1,000 originators that deal with Investor A, only 76 originators are trusted originators and have greater access within the system. Therefore, those trusted originators are able to access and manipulate a specific set of data fields. Another set of less trusted originators may be to manipulate a different set or subset of fields. Yet another set of originators may not be able to manipulate any data fields within the documents. Investors are able to identify originators in groups or on an individual originator basis. The investor may even assign individual originators, different access rights dependent on the specific loan program selected.

One example of the need for form level editing exists for construction mortgage riders when an individual's name may be able to be changed on one particular document such that the document instead of reading “Bob Smith” reads “Robert Smith,” or if a different individual must be named, reads “Robert Jones.” All other documents still contain the originally specified name and remain consistent throughout the loan package. This is particularly important where originators and investors deal with non-standardized, specialized, or infrequently handled loan types.

The present invention also allows originators to add additional forms to individual loan packages. The investor grants rights to originators as to what documents the originators can add to specific loan packages. In most cases, investors may restrict the package to the set of documents specified by the investor. Different access rights may be used for different originators. An investors' in-house mortgage department may be considered as an originator to whom may be granted greater rights based on their direct relationship.

The additional forms are contained within a form library. The form library provides the originators access, dependent on their specified rights, to all the forms available. When an extra form is to be included in the document package, the form is automatically completed with data received in the setup, input, and audit phases. Therefore these documents are entirely consistent with the rest of the package. Once the additional form is completed, the audit may be repeated to ensure the added documents are consistent within the loan package.

When additional documents are added to an individual loan package, investor and compliance rules verification should be repeated to ensure that the added documents and data are compliant with individual investor and compliance rules. Furthermore, there may be additional business rules for those additionally added documents.

For example, if an affidavit is included, there may be additional rules requiring that affidavit to be properly signed, notarized, and provided to the investor-depending on what the affidavit specifically addresses. Following the addition of documents and direct data manipulation for specific documents, the originator has the option of previewing the documents by selecting individual documents or the entire package of documents for review. After this review, the finalized data set at network server 18 in FIG. 1 is used to populate document templates 50 resident within a forms library within network server 18. These documents are then provided via a download, print, fax, or other manner as is known to those skilled in the art for execution.

In FIG. 1, documents 26 may be sent as download 40 or e-mail 42 in a PDF document format. One aspect of PDF documents provides the ability to disable the print function. This comprises setting a flag in that PDF document such that it prevents users from printing the documents until those documents are formally delivered. Similarly, the PDF documents may be delivered in a read only format such that users do not have the ability to edit PDF files. Documents may also be supplied in the PCL format or any other format as known to those skilled in the art. In many instances PDF may be preferred as the PDF file type and reader is present on almost every existing personal computing system.

Different types of document packages may be delivered to different locations. In the example discussed in FIG. 7, the package is to be delivered to Executive Home Mortgage Co. via the Web as a complete package.

The second package shown in FIG. 7 is for “Loan Closing Services,” where the package is Fed Ex'ed and contains only user-selected forms. User select means that the user specifies which documents are to be specifically contained within that package.

The third package illustrated is for “Fremont Investment & Loan.” This package is to be delivered via fax according to the instruction in recipient table 46, and will be a customized “mini” package based on the business rules supplied by that investor. These document sets are based on the specific loan packages and may differ depending on the investor. In many cases, investors may specify a document package comprising a Note, a Deed of Trust, and an Assignment to be provided to the investor, while a copy of all other documents are provided to the closing agent. This provides additional security in that the original documents provided to the closing agent can be compared to the second original provided to the investor. With these two originals, investors can quickly identify changes to the executed documents by comparing key documents or the entire document package to the second original. After closing, but before funding, the closing agent may be required to provide copies of certain documents to the investor wherein those faxed documents are compared with the second original. This comparison ensures there are no discrepancies on key fields. This verification prevents key aspects of the mortgage from being changed. The signed copy of the Note, Security Instrument, and Truth and Lending Statement are such documents that may be verified to ensure there are no discrepancies. This facilitates the review or audit of the signed documentation in real time prior to funding.

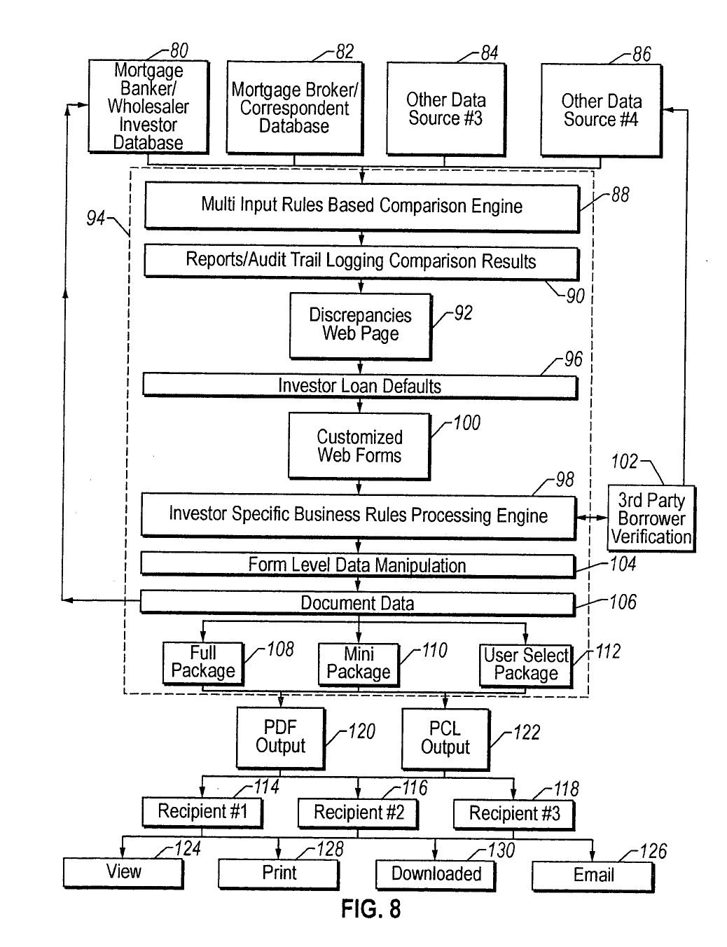

Information flow within the present invention is further illustrated in FIG. 8. In this flowchart, investor database 80, mortgage originator database 82, and other databases 84 and 86 are used to supply data to multiple input rules based comparison engine 88. Databases 84 and 86 may comprise tax databases, wherein appraised or accessed property values for existing properties can be directly imported from local tax records; IRS data to verify employment and income; or credit data from the credit agencies. Multi-input rules based comparison engine 88 compares the data from multiple and diverse databases 80, 82, 84, and 86 to create a comparison results report 90 for display in discrepancies report 92. A screenshot of these results was provided earlier in FIG. 2, wherein discrepancies between input databases are directly presented to users with rules as to which data will be utilized for mortgage documentation preparation. These rules specify which databases may be used for specific fields or the option to choose which database information will be used.

Once the discrepancies have been reconciled, additional data is supplied by server 18 of FIG. 1 to loan documentation preparation engine 94 prior to the input phase of the loan documentation process. This data is processed with investor loan defaults 96 and investor business rules and compliance requirements to generate customized web forms 100. These terms may govern late fees, “short pays”, interest rates, interest rate lock expiration dates, and other such information such as known to those skilled in the art. Compliance requirements are also used to ensure that costly mistakes are avoided.

Business rules process engine 98 verifies the data associated with the originators input from intelligent data collection forms 100. Business rules process engine 98 can also verify data with third party sources 102 or databases 84 and 86 such as tax assessor's office, credit bureaus, employment verification agencies, as well as IRS information associated with income. Following the completion of an audit and reconciliation of discrepancies the data by business rules process engine 98, the originator may view and manipulate form level data through a form level data manipulation interface 104. This privilege is granted and assigned to individual originators by investors. The originator may add additional documents; wherein these documents are populated by data previously provided to forms 100, as well as databases 80, 82, 84, and 86. Following the manipulation of any form level data, or the addition of any documents from the forms library, the business and compliance rules should be executed once more by process engine 98. When this additional audit is complete and no further changes are anticipated, the document data is finalized as data set 106 and the documents are delivered as a closing package 108 to the closing agent. A “mini” package 110 comprising a second original for verification purposes may be provided to the investor. Additionally, a “user select” package 112 may be delivered.

Documents are delivered to various recipients 114, 116, and 118 by various channels. Such channels include a Web-based viewing 124, e-mail 126, direct printing 128, or downloads 130 of PDF, PCL or other file formats, as is known to those skilled in the art.

The forms library comprises an extensive library of customized forms to ensure superior quality document appearance and the ability to create regulatory compliant documents for all states and potentially all residential loan programs. These documents may address an unlimited number of loan types, which include, but are not limited to, FHA, VA, standard FNMA/FHLMC Conventional, adjustable rate loans, balloon loans, sub prime, buy down, second liens, interim construction loans, home equity loans, one time closing mortgages, home improvement, loan modification or principal reduction loans, first liens, timely payments reward loan, a loan where only an interest is paid, bridge loans, bond loans, negative amortization, or loans that have pre-payment penalties.

The present invention provides an expandable solution wherein the growing number of business and compliance rules may be addressed in a logical manner in order to prevent confusion by ensuring that constant changes encountered in the various mortgage programs are observed. This helps to ensure a high level of quality and the necessary flexibility to address a wide variety of situations.

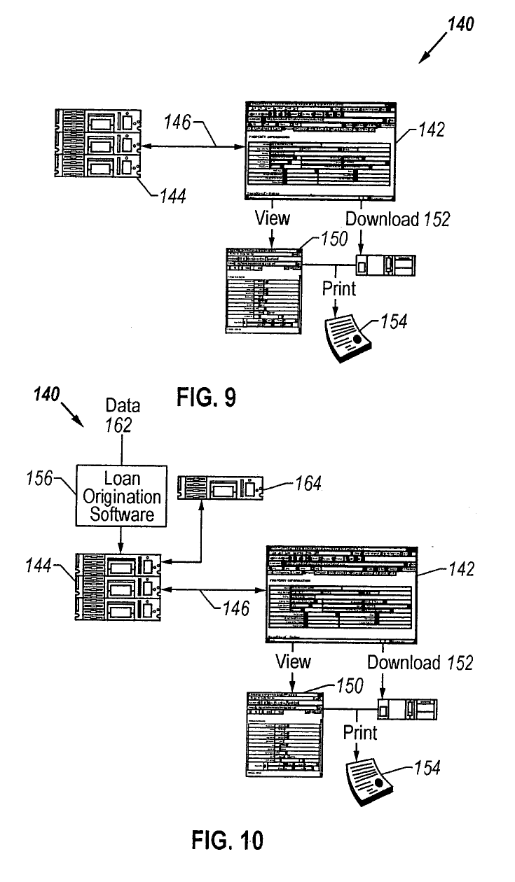

FIG. 9 illustrates a simple version of the present invention wherein users 140 interact, via a Web browser 142, with server 144 via a network or Internet connection 146. This solution requires extensive manual input to server 144 via interface 142.

After data has been provided to server 144, documents 148 are generated and viewed by user 140 via a user interface 150. A final set of documents 154 is typically sent as download 152 for printing prior to closing.

A more advanced embodiment depicted in FIG. 10 uses software package 156 to supply data 162 to server 144. User 140 then views the documents via user interface 150. This data is supplemented by investor data sources 164 and additional data submitted via interface 142. Next, the documents are provided to the user as download 152 for printing by the closing agent. This solution automates the input process and reduces manual input, but fails to reconcile data 162 with the investor data sources 164. In contrast, the present invention provides an advanced system wherein multiple databases are accessed by the software engine resident on server 144 to prepare the loan documents.

The present invention provides a significant advantage in the high level of automation, which eliminates repetitive manual input tasks and performs automatic data integrity checks that prevent transcription errors and other costly inconsistencies.

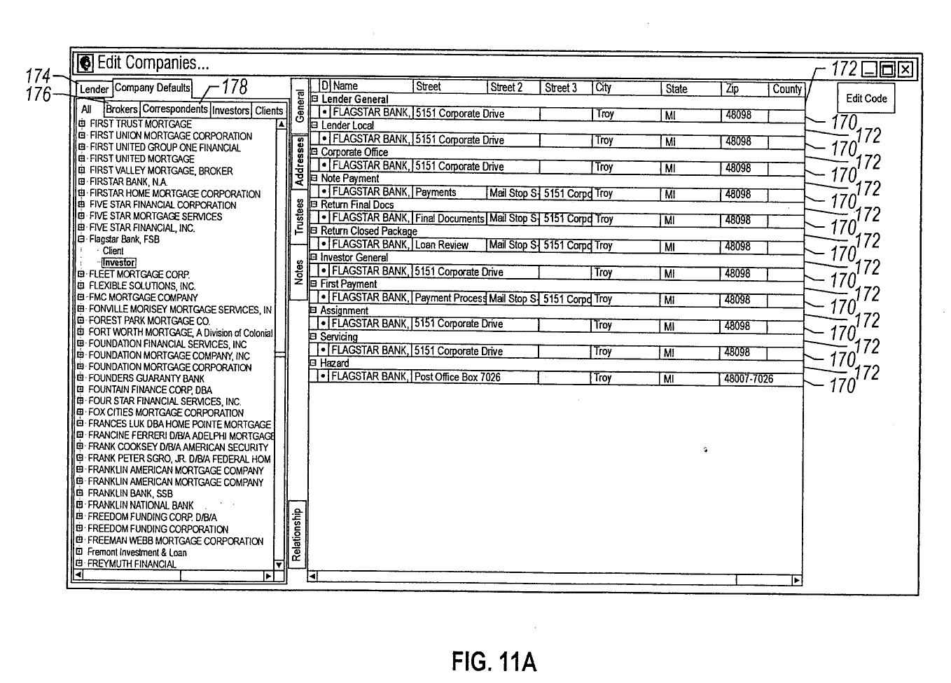

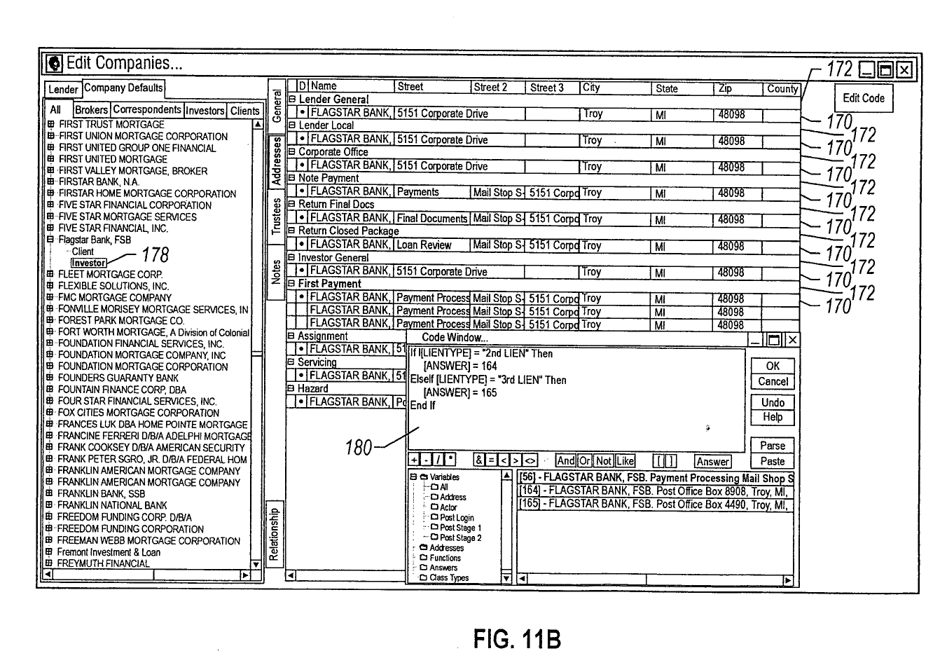

FIG. 11A provides a screenshot that illustrates a variety of addresses 170 and address rules 172 associated with various investors, lenders 176, brokers, correspondent banks 170, etc. These include entity specific data associated with the various loans. FIG. 11B illustrates one such rule that specifies where payments are to be sent for “Flag Star”. FIG. 11B depicts that an individual investor 178 such as “Flag Star” may have several different addresses 170 at which payments should be received, depending on the loan type. More specifically, dialog box 180 shows that if the loan is a “2nd lien” or “3rd lien”, different addresses 120 are to be selected.

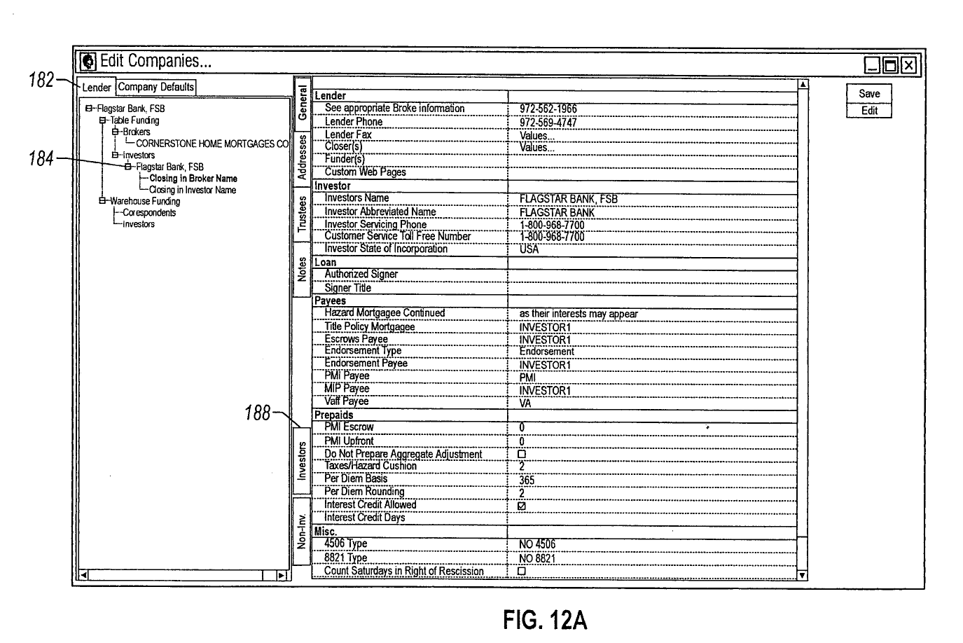

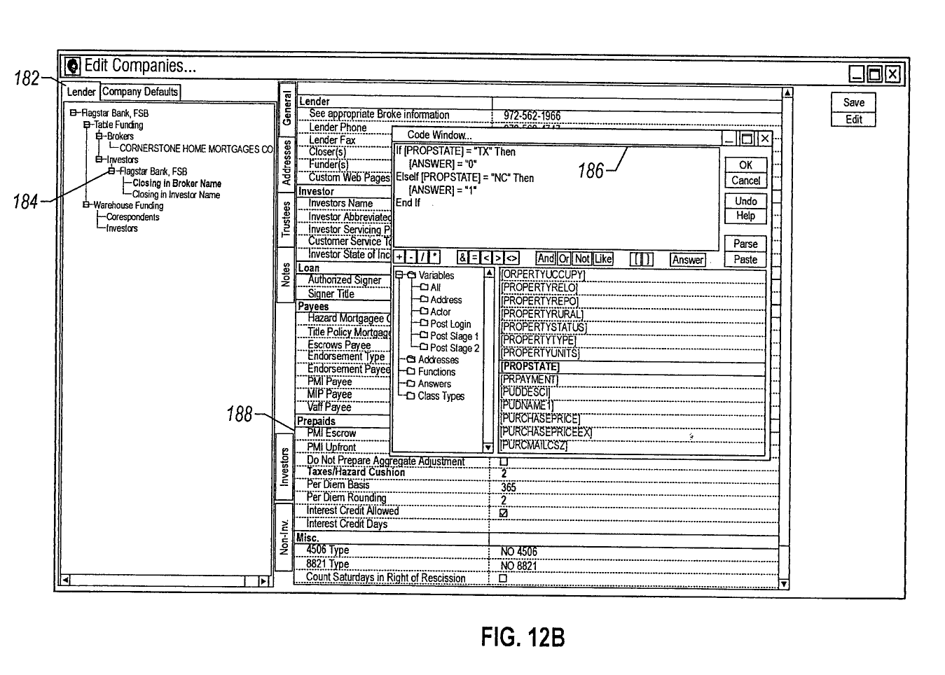

FIG. 12A provides a screenshot to illustrate various defaults associated with an individual company or lender. The defaults shown here are for Flag Star FSB which is serving as investor 184, information, investor name, who the authorized loan officers are, as well PMI recipients, escrow recipients, MIP payees, or whether or not there are prepaid PMI escrow, taxes, and hazard insurance, or other such data. FIG. 12B illustrates in dialog box 186 that depending on the state in which the property is located, different requirements are made. For example, the escrow reserves to be maintained within the escrow account vary between states. The rule provided in dialog box 186 shows that different reserves are required in PMI escrow 188 if the property and loan are to be located in Texas or North Carolina, as opposed to other states.

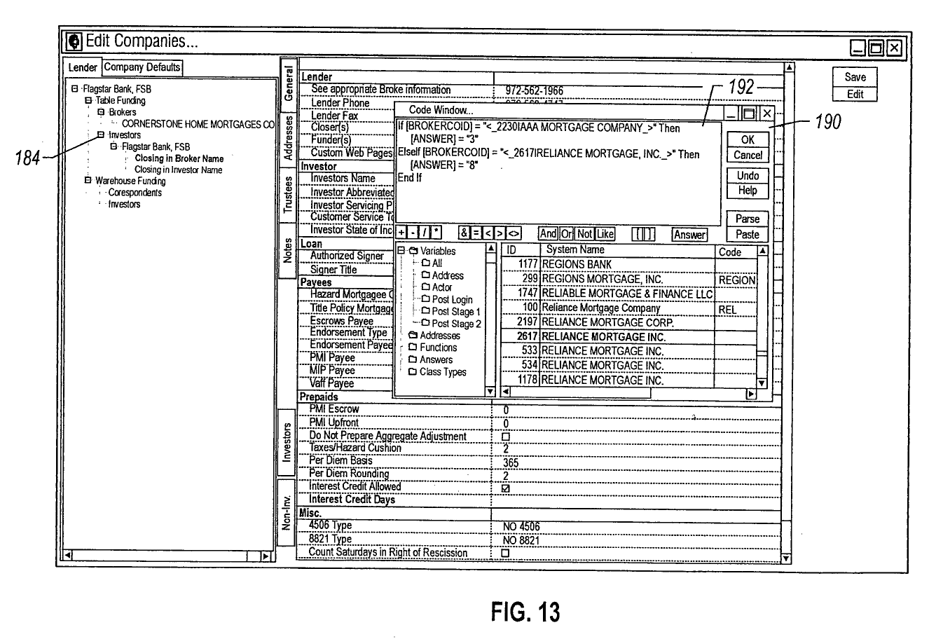

FIG. 13 illustrates that business rules may be associated with specific originators. There may be instances where investor 184 may wish to preclude the originator from working with or may have to specify that the originator work with specific PMI, title, or other companies when preparing mortgage information. This is shown in window 190, wherein dialog box 192 provides specific options depending on the I.D. of the originator.

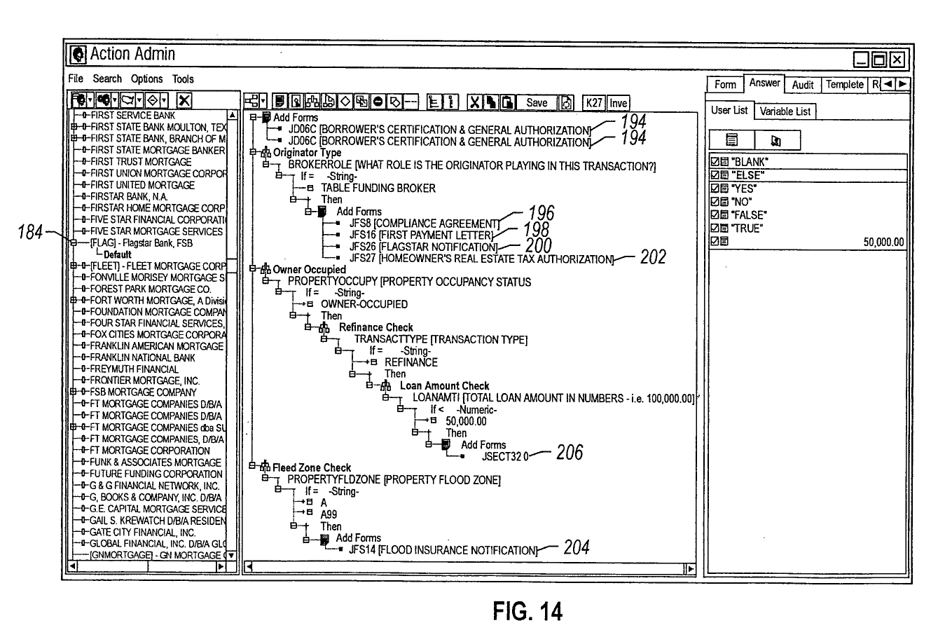

FIG. 14 depicts the loan forms 194 to be associated with an individual loan and how document packages may differ, depending on such things as whether or not the owner is to occupy the property or whether or not the property is located within a flood zone. Specifically, Flag Star Bank sets a default requirement of including forms JD06C in all loans. Should Flag Star, investor 184, fund the originator that Compliance Agreement 196, First Payment Letter 198, Flag Star Notification 200 and Homeowners Real Estate Tax Authorization 202 are to be included. Further Flood Insurance Notification 204 is required if the property is in a flood zone.

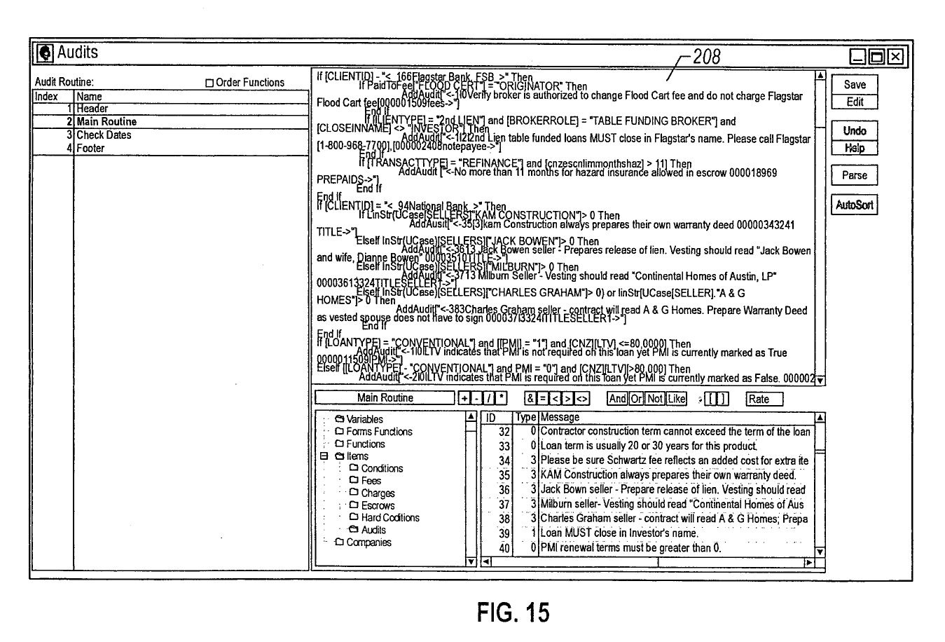

FIG. 15 is associated with configuring the rules based audit engine. This engine determines any improprieties or inconsistencies in the system such as whether or not a fee is included for an individual originator or investor, who the release of the lien is prepared by, the name of the individual to whom the loan must be closed, and the mortgage insurance requirements. More specifically, the logic provided in box 208 specifies whom fees for flood insurance are to be paid dependent on who is issuing the flood certification. Another logical statement made in box 208 flags the need for PMI dependent on the loan to value ratio for the loan. Yet another logical statement made in this loan addressed the preparation of warranty deeds or the preparation of lien releases.

In certain embodiments of the present invention, after the discrepant data has been identified and it has been determined which values are to be used, server 18 may write the finalized version of data to be used to the originator's or investor's database after audits, user verification and documents have been delivered. An audit engine may maintain a log of which fields have been altered and by whom they were altered. For an item that originator 12 is unable to manipulate, originator 12 must contact investor 28 to have the investor change the items.

The present invention provides a significant improvement over existing systems in that the present invention allows the originator or the investor to generate high quality, regulatory compliant, customized documents for unlimited loan types while minimizing errors associated with data entry in the residential loan documentation preparation process. This is accomplished by the compilation and reconciliation of data from diverse sources, which, in turn, is used to populate document templates.

The present invention also allows the investor to maintain control of the document preparation process and ensure that various compliance requirements are met. This reduces costs and demands on staff associated with individual mortgages. Another advantage lies in the fact that the present invention provides a user interface that tailors itself to a wide variety of loan programs.

Large investors often purchase mortgages in pools from correspondent banks. Use of the present invention by correspondent banks, helps ensure that their loans comply with the business rules and compliance requirements associated with individual loan types and investor's business rules for investors they intend to sell their mortgage to. This helps eliminate potential costly errors, which arise when their mortgages are to be sold. Investors pool mortgages not only from correspondent banks, but also mortgages purchased directly from originators, and mortgages prepared and funded by their in-house departments. The difference associated with these channels is that mortgages initiated by originators or investor in-house departments are guaranteed at their inception by the investor. Originators do not guaranty their loan to the investor. Quality assurance is the responsibility of the investor. The correspondent bank initially guarantees loans initiated by correspondent banks. Investors have the option of not purchasing defective loans from correspondent banks.

Thus, the present invention not only provides a solution for a large institutional investor's retail division, but also a solution for the institutional investor's direct sales of loan and the potential acquisition of loans from other institutions by establishing a proactive quality standard and auditing process associated with these loans. This ensures uniformity throughout loan documentation, the proper application of audits, investor business rules, and compliance rules prior to closing individual loans. Furthermore, this helps ensure that the loans are both insurable and marketable and significant costs due to errors are eliminated. Investors may choose to work only with correspondent banks that have established a review process such as that provided by the present invention. In other words, institutional investors may more willingly purchase loans prepared by correspondent banks using the present invention and state that using the present invention will facilitate the purchase and acquisition of those loans initiated by correspondent banks. A large difference between the originator and the correspondent initiated loan is that when the originator closes an individual loan, the investor's money funds the closing. That is not the case when a correspondent bank is utilized. Correspondent banks fund their own loans, which are later sold. Defects within the loan give investors the ability to require correspondent banks to discount their loans based on those defects.

The present invention provides a great number of advantages over prior existing loan documentation preparation systems. Primarily, the present invention prevents costly errors, thus reducing post-closing costs associated with loans. These errors often cost tens of thousands of dollars, dependent on the discounts necessary to compensate for those errors. The present invention also provides a system and method wherein other information or valuations, which have not traditionally been properly audited prior to closing, may now be proactively examined. A reduction in the number of these errors reduces demands placed on staff. Furthermore, the present invention allows investors to safely offload documentation preparation to originators with specific limits as to what actions originators may perform dependent on investors' business rules and other compliance regulations.

The present invention provides yet another important advantage to the residential loan industry. The present invention increases process efficiency by addressing past difficulties found in accumulating, accessing, compiling, and transferring data that traditionally have slowed down the origination, underwriting, and closing process resulting in reduced profit margins. One of the most important transfers of data is from the investors and originators to the residential loan package. Further, the present invention provides a document preparation system that is capable of applying the Mortgage Industry Standards Maintenance Organization (MISMO) standard for electronic information associated with residential loan packages. This helps to ensure that data received from originators and investors as well as other diverse databases can easily be compiled and reconciled. The application of this or other similar standards helps to eliminate problems that slow the document preparation process. This standard provides a content and format structure under which data may be transferred among parties to a transaction, including the originator, investor, lender, third party report providers, and rating agencies. However, individual parties may supplement this standard with their own unique requirements.

Although the present invention has been described in detail, it should be understood that various changes, substitutions, and alterations can be made hereto without departing from the spirit and scope of the invention as described by the appended claims.

What is claimed is:

1. A system for preparing documents, comprising:
a first database, wherein said first database stores data provided by a first user;
at least one additional database, wherein said at least one additional database stores data provided by at least one additional user;
a comparison engine, located on a network server, and coupled to said first and said at least one additional database by a network connection, wherein said comparison engine compares data provided by said first user and said at least one additional user and identifies discrepancies between said data;
a forms library containing document templates;
a documentation preparation engine operable to receive additional information required to prepare the documents, wherein a compliance engine determines if reconciled data and said additional information are consistent with procedures for processing said data, and wherein noncompliant reconciled data or additional information is further reconciled; and
a documentation delivery engine operable to populate data fields within said documents templates and deliver said populated documents.

2. The system for preparing documents of claim 1, wherein said first user is a mortgage originator, and said at least one additional user comprises an investor.

3. The system of claim 2, wherein said first user enters data into said first database via a loan origination software package.

4. The system of claim 2, wherein procedures for processing said data provided by said first user or said at least one additional user comprise business rules.

5. The system of claim 1, wherein said comparison engine writes said reconciled data to said first database or said at least one additional database.

6. The system of claim 1, wherein the documents comprise loan-closing documents.

7. The system of claim 4, wherein said business rules comprise business logic associated with said first user and said at least one additional user.

8. The system of claim 7, wherein said business rules further comprise requirements imposed by governmental entities, their agencies, or their vendors.

9. A system for preparing loan documents, comprising:
a first database, wherein said first database stores data and procedures for processing said data provided by a mortgage originator;
at least one additional database, wherein said at least one additional database stores data and procedures for processing said data provided by an investor;
a comparison engine, wherein said comparison engine compares data provided by said mortgage originator to data provided by said investor and identifies discrepancies between said data provided by said mortgage originator and said investor;
a user interface wherein said mortgage originator or said investor reconciles said discrepancies;
a forms library containing loan document templates;
a documentation preparation engine operable to receive additional information required to prepare the documents, wherein a compliance engine determines if said reconciled data and said additional information are consistent with said procedures for processing said data provided by said mortgage originator and said investor, and wherein noncompliant reconciled data or additional information is reconciled; and
a documentation delivery engine operable to populate data fields within said loan document templates and transmit information consistent with procedures provided by said mortgage originator and said investor, and deliver said populated documents.

10. The system of claim 9, wherein said mortgage originator enters data into said first database via a software package.

11. The system of claim 9, wherein said procedures for processing said data provided by said mortgage originator and said investor comprise business rules and or compliance requirements.

12. The system of claim 9, wherein said comparison engine writes said reconciled data to said a first database or said at least one additional database.

13. The system of claim 9, wherein said at least one additional database comprises at least one database selected from entities involved in the loan transaction and their vendors.

14. The system of claim 11, wherein said business rules comprise business logic associated with said first user and said at least one additional user.

15. The system of claim 14, wherein said business rules further comprise requirements imposed by governmental entities, their agencies, or their vendors.

16. The system of claim 11, wherein said compliance requirements are issued by at least one entity selected from the group consisting of federal government agencies, state governments, local governments, banking regulators, FHA, VA, and FNMA/FHLMC.

17. A method of preparing loan documents, comprising the steps of:
storing data and procedures for processing said data provided by a mortgage originator in a first database;
storing data and procedures for processing said data provided by an investor in at least one additional database;
comparing data provided by said mortgage originator to data provided by said investor;
identifying discrepancies between said data provided by said mortgage originator and said investor;
reconciling said discrepancies;
supplying additional information to prepare the documents to a documentation preparation engine;
auditing said reconciled discrepancies and said additional information with a compliance engine that determines if said reconciled data and said additional information are consistent with said procedures for processing said data provided by said mortgage originator and said investor, and wherein noncompliant reconciled data or additional information is reconciled;
populating data and additional information consistent with procedures for processing said data provided by said mortgage originator and said investor into documents contained within a forms library; and
delivering said populated documents for execution.

18. The method of claim 17, wherein said mortgage originator enters data into said first database via a software package.

19. The method of claim 17, wherein said procedures for processing said data provided by said mortgage broker and said investor comprise business rules and or compliance requirements.

20. The method of claim 17, wherein said comparison engine writes said reconciled data to said first database or said at least one additional database.

21. The method of claim 20, wherein said at least one additional database comprises at least one database selected from the group consisting of property tax databases, independent property valuations databases, income/employment verification databases, income tax databases, and credit databases.

22. The method of claim 19, wherein said business rules comprise investor business rules, regulatory compliance requirements, or insurability requirements.

23. The system of claim 19, wherein said compliance requirements are issued by at least one entity selected from the group consisting of federal government agencies, state governments, local governments, banking regulators, FHA, VA, and FNMA/FHLMC.

24. The method of claim 17 further comprising the step of:
manipulating individual data fields within said populated documents.

25. The method of claim 17 further comprising the step of:
allowing said broker to select additional documents from said forms library, wherein said additional documents are populated automatically.

26. The method of claim 24, further comprising re-auditing the documents with said compliance engine and reconciling discrepancies created by manipulating individual data fields within said populated documents.

27. The method of claim 24, further comprising re-auditing the documents with said compliance engine and reconciling discrepancies created by adding additional documents.
